(19) United States
(12) Patent Application Publication
(10) Pub. No.: US 2005/0187814 A1
(43) Pub. Date: Aug. 25, 2005

(54) Voter strategically targeted analyzing and reporting system

(76) Inventors: Hector Yanez, Austin, TX (US); Frank Yanez, Austin, TX (US); Valentin R. Yanez, Austin, TX (US); Philip A. Ruiz, Lockhart, TX (US)

Correspondence Address: JOHN VIRA, 326 Hackberry, Lockhart, TX, 78644, US

(21) Appl. No.: 10/783,545

(22) Filed: Feb. 20, 2004

(51) Int. Cl. G06F 17/60

(52) U.S. Cl. 705/12

(57) ABSTRACT

A Voter Strategically Targeted Analyzer and Reporting System provides political candidates with a means for continuously paring down the eligible voter list, as well as a method for reporting. A targeted voter list is filtered per campaign parameters to create a latest updated targeted voter list. The updated targeted voter list is then filtered with early voting data to create a latest targeted voter data file that is a subset of the targeted voter data file. A portion of the list may downloaded to field aides for data collection. Downloading to the filed aide may include the use of a processing device. In a second embodiment, the display of data from the targeted voter data file is attached to GIS coordinates to create a graphical representation of the data collected. Groups of data may then be generated based on geographic location to provide a visual representation of campaign progress.

### BACKGROUND OF THE INVENTION

1. Field of the Invention

The present invention relates to voting and, more particularly, but not by way of limitation to a method of accessing public data to strategically target voters in a political campaign.

2. Description of the Related Art

Political campaigns can be broken into several phases: the pre-vote stage, the early-voting stage, and the election day stage.

In the current system of voting and voting data, campaigns may purchase previous voting data for a county from the state. This data file is a listing of registered voters, their voting history, their personal information, as well as other pertinent and non-pertinent items. The data file may be viewed in a printout or an electronic format, however, the data file very large and virtually unmanageable. In most counties, the data file is never used.

Typically, campaigns are run on a strategy based on historical data, party trends or the personal expertise of the campaign manager. In most cases, campaigns have limited funds and a limited workforce, usually volunteers. In today's political arena, campaigns are hard pressed to be able to specifically target voters that have not yet voted. In the pre-vote stage, all registered voters, as well as unregistered voters, are targets for campaign reminders, including political emdorsement signs, campaign phone calls, and door-to-door visits.

In the early voting stage, especially in a tight race, campaigns attempt to work harder, but usually do not know where to focus campaign resources. They then resort to the blanket calling and blanket door-to-door visits, therein calling and visiting households that have already voted or have no interest in the candidate. Either way, the campaign is losing the precious manhours at their disposal.

Historically, campaign phone calls equate to a thirty percent successful vote ratio. On the other hand, door-to-door visits can range from a twenty to eighty percent successful vote ratio. Illustratively, it has been shown that the act of the candidate personally asking for an individual's vote has a seventy percent successful vote ratio. Thus, efficiency numbers for voter contact and the number of votes cast would be higher if the campaign was able to focus its energies on the correct voters.

Accordingly, there is a long felt need for a data management tool that can provide candidates with semi-real-time data and reports to target only voters that have not yet voted, therein maximizing the efficiency of the available campaign workforce.

### SUMMARY OF THE INVENTION

In accordance with the present invention, a Voter Strategically Targeted Analyzer and Reporting System provides political candidates with a means for continuously paring down the eligible voter list, as well as a method for reporting. A targeted voter list is filtered per campaign parameters to create a latest updated targeted voter list. A second list is created using data from early voting information. The updated targeted voter list is then filtered with the early voter list to create a latest targeted voter data file that is a subset of the targeted voter data file, therein identifying eligible voters that have not voted in the current election.

The process may be repeated on a routine basis to continuously pare down the targeted voter list. Further embodiments include downloading at least a portion of the latest targeted voter list to a field aide for data collection and then updating the latest targeted voter data file to further pare down the latest data file. The downloading of the subset to the filed aide may include the use of a processing device.

The display of data may include overlaying a targeted voter data file with GIS coordinates to create a graphical representation of the data collection. Groups of data may then be generated based on geographic location and filtered to provide a visual cue to campaign progress.

It is therefore an object of the present invention to provide a means for paring down the eligible voter list.

It is further an object of the present invention to handle early voting data in an election campaign.

It is still further an object of the present invention to provide a means for tying the eligible voter data to a graphical display.

It is still yet further an object of the present invention to provide a vehicle for updating the latest targeted voter list with field data.

### BRIEF DESCRIPTION OF THE DRAWINGS

FIG. 1 is a flowchart of the method steps according to the preferred embodiment.

FIG. 2 is a flowchart of the method steps for extracting GIS information.

FIG. 3 is a representation of the network according to the preferred embodiment.

FIG. 4 is a representative diagram of an electronic processing device according to the preferred embodiment.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

The following system is a method for enabling political campaigns to strategically focus campaign efforts and resources on voters that have not yet voted. A targeted voter database is created and pared down through the use of field data. Further embodiments of this invention include the ability to provide campaign personnel with personal data acquisition and manipulation tools to conduct routine political campaign solicitations efficiently, both in the field and at the campaign headquarters. A reporting and updating regime, therein, is created.

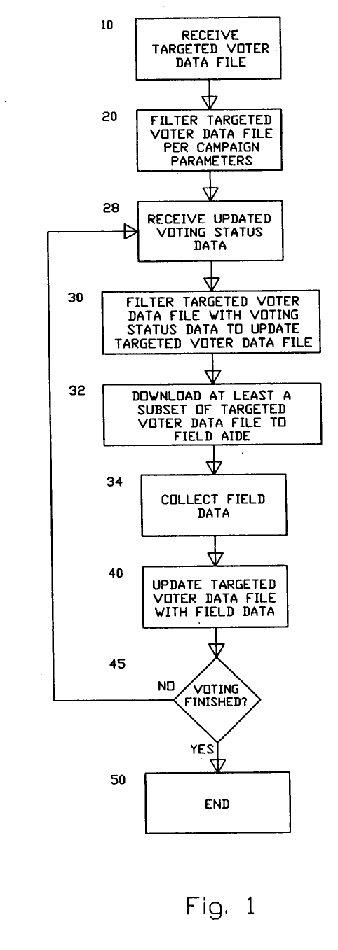

As shown in FIG. 1, step 10, a political candidate or political campaign purchases a targeted voter data file from a governmental entity, in this preferred embodiment, the state of Texas. The candidate may purchase the data package for a specific county. The selection is driven by the boundaries of the areas that a candidate or campaign desire to target. The data file is delivered on a CD-ROM. In this preferred embodiment, a Filemaker Pro database software is used to access the data. The data file, as purchased, is a registry of all registered voters from the previous year, their personal information, such as addresses, phone numbers, their voting histories, as well as their registration numbers. The data set further includes numerous data fields that have no application to the campaign. For counties that have a significant number of registered voters, the database is extremely large, cumbersome and virtually unusable.

Once the data package is received, the targeted voter data file is filtered based on campaign parameters as shown in step 20. Campaign parameters are the guidelines set by the campaign or the campaign manager to target a general segment of the voting population. Campaign parameters may be based on aggregate data, including unwanted voting precincts and parties or may be specific targeting of voter profiles, such as ethnicity, age or voting history, to access specific portions of the voting population. Step 20 may be required for all of the purchased targeted voter data files, as the size of the data file and manipulations are essentially unusable. The generated targeted voter data file is a subset of the original targeted voter data file. Therein, the latest targeted voter data file provides the campaign with a list of persons that have met the selection criteria as set by the campaign. The filtering of the targeted voter data file is accomplished with a processing device, as a manual process would not be feasible.

After filtering of the targeted voter data file, the process moves to step 28, where the campaign receives a voting status data file representing those individuals that have exercised their early-voting priviledge. Early-voting data is available after each early-voting session, daily in this preferred embodiment, from the County Judge. Early-voting data is obtained and entered into a voting status data file. If early-voting has not yet commenced, the process then moves to step 30.

Step 30 provides for filtering the targeted voter data file with the most current voting status data file, therein removing individuals that have exercised their voting privilege from the targeted voter data file. However, if the early-voting sessions have not yet commenced, no data is filtered in step 30, and the process moves to step 32 where data is downloaded for field use.

In this preferred embodiment, at least a portion of the targeted voter data file is downloaded to a field aide via a transportable processing device for canvassing operations and field data collection. Canvassing operations may include door-to-door visits, phone banks, political sign placement and surveying operations. During those canvassing efforts, field data may be gathered on-site, as well as off-site. Field data may include voting preference, political sign desired, GIS related information or updating of personal information, such as deceased or address change.

The downloaded portion of the targeted voter database may also be filtered or segmented by county, precinct, gender, age, street name, voter last name or the like, to selectively access any particular segment of the population. The ability to further filter and segment the downloaded database provides the field aides with the ability to conduct canvassing operations by streets, last names, sex, voting history, or the like, therein further targeting the targeted voter data file. The filtering process further provides the on-demand ability to generate a listing of individuals that have requested political signs, need voter registration cards or need a ride to the polls. Further advantages of the downloaded portions allow the field aides to work particular segments of the population over long periods of time, illustratively, days or weeks.

In the pre-early-voting stage of a campaign, the targeted voter data file may be updated at predetermined intervals with field data as prospective voters are phoned or visited by campaign workers to build a central databank of voter information, step 40. In an alternative embodiment, the targeted voter data file may live for continuous updating from on-site or off-site operations. Once the targeted voter data file is updated, the process moves to step 45. If the election is over, and voting has finished, the process moves to step 50, the end. If the possibility of voting still exists, the process returns to step 28, wherein an updated voting status data file is received.

At this time, the campaign creates or associates a new or updated voting status data file representing those individuals that have gone through the latest session of the early-voting process. Early-voting information is available after each early-voting session from the governmental entity conducting the election, daily in this preferred embodiment.

The process then moves to step 30, where the latest targeted voter data file is filtered using the voting status data file to generate a latest targeted voter data file. The new targeted voter data file is a subset of the filtered targeted voter data file, as the individuals that have exercised their early-voting privilege have been removed. The targeted voter data file is now the most accurate listing of voters that have not yet voted, and may now be used in contacting eligible voters that have not yet voted. A portion of the targeted voter data file may then be downloaded to campaign personnel for generation of field data as shown in step 32. The download may be a printout format or may be in an electronic format for a transportable processing device such as a laptop, PDA, tablet, etc. for campaign personnel use. Step 34 provides for continued field data generation. Field data may include personal information, voting status, voting support, as well as early voting data.

Steps 28-45 may be repeated every day of early voting to produce a yet shorter targeted voter data file, therein increasing the efficiency of the campaign workforce. The ability to eliminate persons that have voted or others that have been filtered out allows the campaign to focus efforts on qualified voting individuals who have not yet voted.

If the early-voting process has ended, step 28 receives no data, but the process continues through steps 30-45, wherein the latest targeted voter data file may be updated. At this point, early voting data is no longer generated, so the process is limited to updating of the latest targeted voter data file, but may be repeated for continuous elimination of voters that have been contacted.

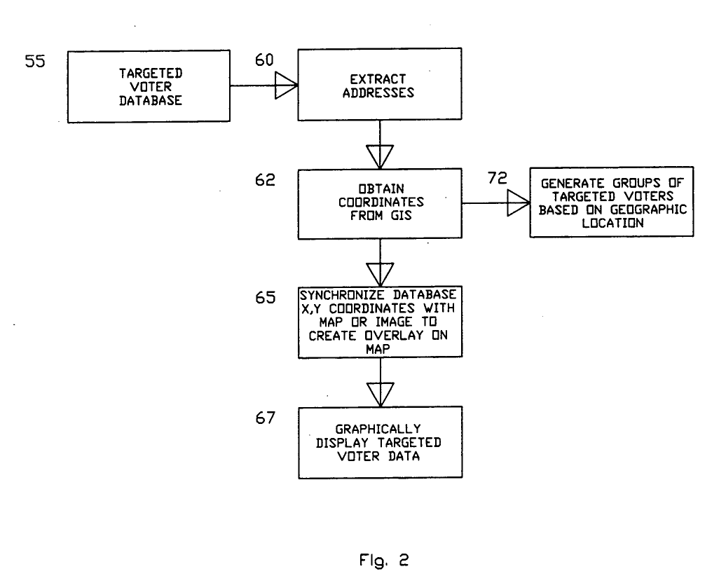

In an alternative embodiment, the process may be used to generate and display voting data in a graphical format based on geographic data. As field aides conduct routine canvassing operations, they may be able to log GIS coordinates for each household, therein adding the information to the targeted voter data file. As shown in FIG. 2, the targeted voter data file may be used to extract the addresses and coordinates from the targeted voter data file, and overlay them onto a digital map to graphically display of the voting data. Alternatively, the campaign may use the graphical display to generate groups of targeted voters based on their geographic location. Herein, the candidate or campaign manager would be able to look at a map of targeted areas, contacted voters and uncontacted voters for analysis and planning.

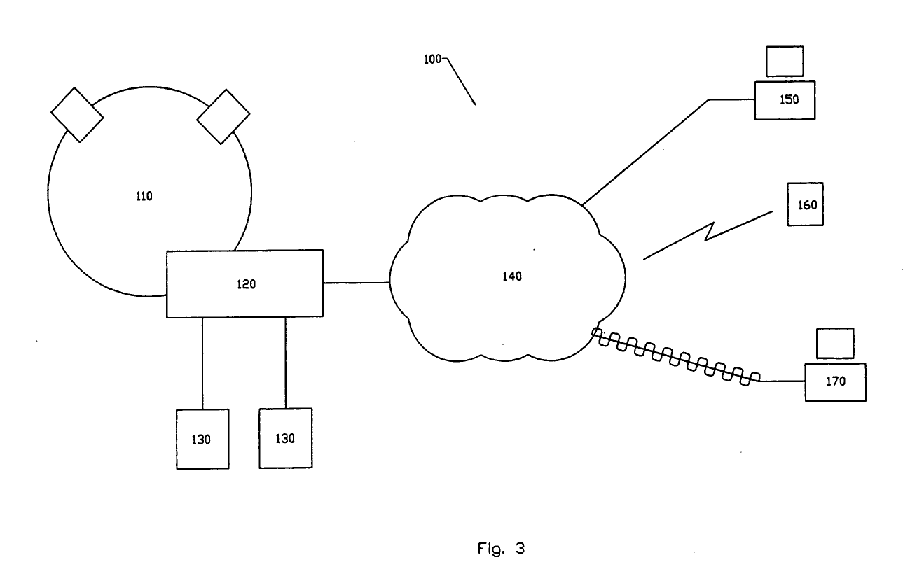

In the simplest form, a host computer may be located in the campaign headquarters for updating a central data file, generating written reports and/or communicating with peripherals as shown in FIG. 3. The campaign may have an internal network, therein allowing campaign workers to work from remote workstations. Downloading of data to the field aides may include downloading to a processing device, such as a PDA (personal digital assistant), a laptop, tablet or other portable processor type device for field data collection.

Data gathering sessions may be followed by uploading of information from the field processing device to the central processing unit to update the targeted voter data file. Updating of the targeted voter data file may be accomplished over a wireless web connection, through a modem, or through a hard-wired line connectable to an internet server. In some cases, the targeted voter data file may be live for continuous updating from both central and remote locations.

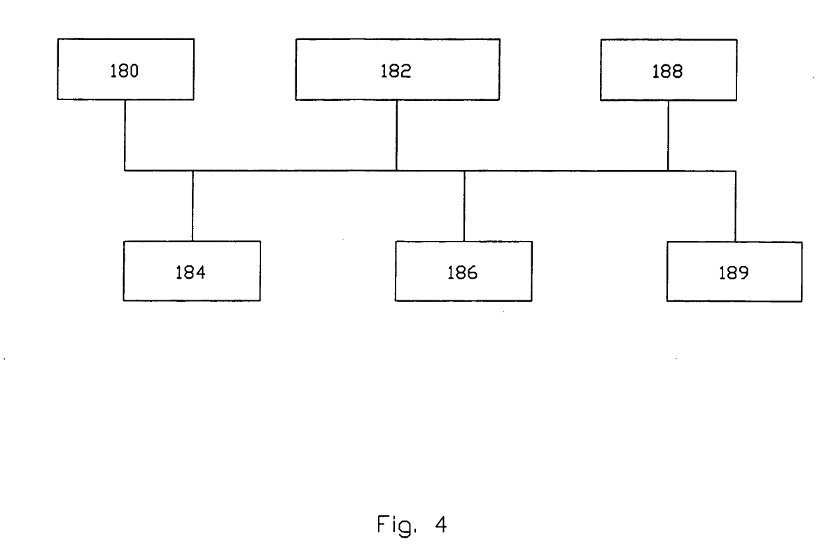

As shown in FIG. 4, a processing device may inlcude a processor, random access memory, non-volatile memory, an input device and a display. The processisng device may further include other peripherals as required to conduct necessary operations.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

1) A method of generating a targeted voter list, comprising the steps of:
a) receiving a targeted voter data file identifying eligible voters;
b) filtering the targeted voter data file per campaign parameters, therein eliminating undesired fields and high risk voters to generate an updated targeted voter data file;
c) creating a latest early voted status data file, therein identifying voters that have voted in the early voting session;
d) filtering the updated targeted voter data file using the latest early voted status data file to generate a latest targeted voter data file that is a subset of the targeted voter data file being filtered, therein identifying eligible voters that have not voted in the current election.

2) The method of claim 1, further comprising:
e) downloading at least a subset of the latest targeted voter data file to a field aide for field data collection.
f) updating the targeted voter data file with field data to generate a latest targeted voter data file.

3) The method of claim 2, further comprising,
g) repeating steps c)-f), therein culling the targeted voter data file until the election has been decided.

4) The method of claim 2, wherein step f) further comprises filtering the targeted voter data file to eliminate voters based on aggregate voter data.

5) The method of claim 1, wherein step e) further comprises downloading at least a subset of the targeted voter data file to a processor device for field data collection.

6) The method of claim 1, wherein steps b) and d) are accomplished with a processor.

7) The method of claim 2, wherein steps e) and f) are accomplished with a processor.

8) The method of claim 2, further comprising:
h) manipulating the downloaded targeted voter data file, or portion thereof, to access further subsets of the downloaded data file.

9) The method of claim 2, wherein step f) further comprises updating the targeted voter data file with field data via a wireless web connection and a wireless device, therein providing continuous updating and reporting.

10) The method of claim 2, further comprising:
g) generating groups of data based on geographic location.

11) The method of claims 1-3, further comprising:
h) displaying data graphically through the use of GIS

12) A method of viewing a targeted voter data file, comprising the steps of:
a) updating a targeted voter data file with GIS coordinates;
b) extracting the GIS coordinates and addresses of the targeted voter data file;
c) overlaying the targeted voter data file onto a digital map using the GIS coordinates;
d) graphically displaying the targeted voter data file overlayed onto a digital map, therein allowing a campaign or candidate to view the data.

13) The method of claim 12, wherein the graphical display of data allows the campaign to generate groups of data based on geographic location.

14) The method of claim 12, wherein the graphical display of data allows the campaign to view both the targeted voter data file and a data map, therein providing a visual representation of the subject areas.

15) The method of claim 12, wherein the graphical display of data allows the campaign to view both the targeted voter data file after filtering per the campaign parameters and the current targeted voter data file, therein providing a visual cue of campaign progress.
